(19) United States
(12) Patent Application Publication
(10) Pub. No.: US 2011/0184460 A1
(43) Pub. Date: Jul. 28, 2011

(54) PACIFIERS

(76) Inventor: Nouri E. Hakim, Monroe, LA (US)

(21) Appl. No.: 12/666,600

(22) PCT Filed: Jun. 26, 2008
(86) PCT No.: PCT/US08/07966

§ 371 Date: Jan. 26, 2011

Related U.S. Application Data
(60) Provisional application No. 60/937,182, filed on Jun. 26, 2007.

(51) Int. Cl. A61J 17/00

(52) U.S. Cl. 606/234

(57) ABSTRACT

Improved pacifiers having less than two air holes within the pacifier shield. In one series of embodiments, a single enlarged air hole is provided through the pacifier shield. In a further series of embodiments, no air holes are provided through the shield, the pacifier shield being designed with arms forming gaps allowing the ventilation of air. In preferred embodiments, a support base extends from the baglet support and a rim extending from the support base such that the baglet support, the support base, and the rim in combination define a single opening in the shield or a gap between the arms of the pacifier shield and the pacifier shield body allowing passage of air therethrough and increasing the safety and comfort of use of the pacifier.

### CROSS REFERENCE TO RELATED APPLICATIONS

This application claims the benefit of and all rights of priority to U.S. Provisional Patent Application Ser. No. 60/937,182, filed Jun. 26, 2007, the disclosure of which is fully incorporated herein by reference.

### BACKGROUND OF THE INVENTION

1. Field of the Invention

The present invention relates to improved baby products in general and more particularly to improved shields for baby pacifiers.

2. Discussion of the Related Art

Parents have long discovered that giving a baby on object to suck on has a calming or comforting effect on the baby. In the nineteenth century, parents would place a small amount of food or granulated sugar in the center of a cloth, gather the cloth into a little ball and tie it tightly with a thread. The baby would suck on the ball containing the food and be contented by the taste of the food as it permeated the cloth.

The pacifier as now widely known settled into its familiar modern form around the beginning of the twentieth century. These early pacifiers generally comprised a handle that could be grasped by the parent or baby and a rubber nipple attached to the handle for the baby to suck on. A shield was interposed between the handle and the nipple to prevent the baby from getting the pacifier lodged in the baby's airway and suffocating. Since those early pacifiers, the basic design has been substantially maintained, but has also been the subject of many variations.

In recent years, government regulations have established guidelines for the manufacture of pacifiers to ensure the safety of the children using them. One requirement imposed upon pacifier manufacturers is that the shield must be of a minimum size and include air passages therethrough to prevent a child from suffocating should the pacifier become lodged in the child's airway. As a result, current pacifiers include a plurality of holes through the shield, serving as air passages. These holes serve as a safety measure, so that if the child should accidentally swallow the pacifier, air can pass through the shield, preventing the child from choking while the pacifier is lodged within the child's mouth or throat. For comfort purposes, the passages can also serve to ventilate the child's face when the child is sucking on the baglet.

### SUMMARY OF THE INVENTION

Further to the present invention, improved pacifiers are provided herein. In accordance with the invention, less than two air holes are placed within the pacifier shield. Thus, the pacifiers of the invention include a single air hole through the pacifier shield, or no air holes through the shield, departing significantly from established designs. In the design with zero air holes, the shield, more specifically, has no closed air holes; instead, the pacifier shield is designed with arms forming gaps allowing the ventilation of air.

Although less than two holes are provided, rather than decreasing the safety of the pacifier, the present invention increases it. The designs of the invention provide an opening or gaps that maximize the air passing through or around the shield even if the pacifier should become lodged in the child's airway. The designs also maximize the air passing through or around the shield for comfort purposes. The pacifiers also preferably incorporate a shield of sufficient size to prevent a child from ingesting the pacifier or having the pacifier become lodged in the child's airway.

Any methods for constructing pacifiers known in the art can be used in conjunction with the present invention, and any prior art structures for pacifiers can be used consistent with the invention, while following the principles set forth herein. In accordance with those principles, for example, the number of holes is minimized such that less than two holes are provided, while the size of the holes are preferably maximized.

In one embodiment, for example, the present invention is directed to a child's pacifier that satisfies the need for a pacifier having a shield with a single large opening to permit the passage of sufficient air therethrough should the pacifier become lodged in the child's airway. The child's pacifier comprises a baglet and a shield. The baglet is typically made of silicone or latex as is known in the art. The pacifier shield includes a baglet support defining an aperture therethrough for receiving and retaining the baglet configured for a child to suckle on. The aperture for receiving the baglet is sealed so as to retain the baglet in a safe and secure fashion (and, accordingly, is not counted among the opening for passage of air described herein). A support base extends from the baglet support and a rim extends from the support base such that the baglet support, the support base, and the rim in combination define a single opening in the shield. Thus, in accordance with this embodiment, the pacifier shield consists of a single continuous arm or rim, which forms the circumference of a single hole.

In a further alternative or additional embodiment, the pacifier includes a pacifier shield consisting of two (or more) arms. In a preferred embodiment, the pacifier shield includes a right arm and a left arm. These arms extend from a body of the pacifier shield, with a gap being provided between the arms and the body. Consistent with the invention, air can pass through this gap.

In one embodiment, the arms do not connect or join together. In an alternative embodiment, the ends of the arms contact each other directly, or the ends of the arms are in contact with a knob or bulb placed between those ends. The knob or bulb can be provided with nubs or bumps thereon, e.g. as a teething surface for the baby. The knob or bulb can be constructed from a material similar to the pacifier shield or from a relatively softer or harder material. Likewise, the knob or bulb can be constructed from or covered with any of the materials used for teethers in the art. Other such teething materials and surfaces as may be employed in the art in the future may also be used for the teething surface of the knob or bulb.

In further embodiments, the arms of the pacifier shield can touch a central portion or post of the pacifier. Or, the arms can also be configured to extend from the pacifier shield's body but not touch the central portion. When the arms are configured to touch they are used to form one hole shield, and when they are configured to not touch they form a zero hole shield configuration, there being a gap between the arms and the pacifier shield body serving in place of a closed hole.

In a further embodiment, the pacifier includes a hinge such that part of the pacifier can rotate or swivel. For example, the pacifier includes a shield having a single arm attached to a post at hinges. The hingers, for example, can each include a small rod that extends from the arm and is inserted into post 56, the rod having an enlarged end to prevent removal, but allowing free rotation of the arms of the pacifier about the post. In a further alternate embodiment, the arms could be connected to the post at a single point, such as using a single hinge at the top of the post.

Accordingly, as discussed herein and illustrated in the figures, in any of the embodiments of the invention, less than two holes (i.e. less than two air holes or air vents) are provided in the shield of the pacifier. This design of the present pacifier provides significantly increased safety over the prior pacifiers of the art. In the event that a child swallows or attempts to swallow the pacifier, the design makes it easier for the child to pull air through the pacifier without choking, irrespective of the orientation of the pacifier in the child's mouth. In such event, the design also makes it easier for the mother or other caregiver to place her or his fingers through the pacifier to pull the pacifier out of the child's mouth.

These and other features, aspects, and advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the accompanying drawings in which:

FIG. 1 is a perspective view of a pacifier embodying the present invention;

FIG. 2 is a front view of the pacifier shown in FIG. 1;

FIG. 3 is a side view of the pacifier shown in FIG. 1;

FIG. 4 is a bottom view of the pacifier shown in FIG. 1;

FIG. 5 is a cross-sectional side view of the pacifier shown in FIG. 1;

FIG. 6 is a front view of a second embodiment of a pacifier shield in accordance with the present invention;

FIG. 7 is a bottom view of the pacifier shield shown in FIG. 6;

FIG. 8 is a side view of the pacifier shield shown in FIG. 6;

FIG. 9 is a front view of a third embodiment of a pacifier shield in accordance with the present invention;

FIG. 10 is a bottom view of the pacifier shield shown in FIG. 9;

FIG. 11 is a side view of the pacifier shield shown in FIG. 9;

FIG. 12 is a front view of a fourth embodiment of a pacifier shield in accordance with the present invention;

FIG. 13 is a bottom view of the pacifier shield shown in FIG. 12;

FIG. 14 is a side view of the pacifier shield shown in FIG. 12;

FIG. 15 is front view of a fifth embodiment of a pacifier shield in accordance with the present invention;

FIG. 16 is a bottom view of the pacifier shield shown in FIG. 15.

FIG. 17 is a series of views of a further embodiment of the pacifier of FIG. 1, in which FIG. 17a is a perspective view, FIG. 17b is a front view, FIG. 17c is a left side view, FIG. 17d is a right side view, FIG. 17e is a top view, FIG. 17f is a bottom view, and FIG. 17g is a back view.

FIG. 18 is a series of views of a further embodiment of the pacifier of FIG. 6, in which FIG. 18a is a perspective view, FIG. 18b is a front view, FIG. 18c is a left side view, FIG. 18d is a right side view, FIG. 18e is a top view, FIG. 18f is a bottom view, and FIG. 18g is a back view.

FIG. 19 is a series of views of a further embodiment of the pacifier of FIG. 9, in which FIG. 19a is a perspective view, FIG. 19b is a front view, FIG. 19c is a left side view, FIG. 19d is a right side view, FIG. 19e is a top view, FIG. 19f is a bottom view, and FIG. 19g is a back view.

FIG. 20 is a series of views of a further embodiment of the pacifier of FIG. 12, in which FIG. 20a is a perspective view, FIG. 20b is a front view, FIG. 20c is a left side view, FIG. 20d is a right side view, FIG. 20e is a top view, FIG. 20f is a bottom view, and FIG. 20g is a back view.

Like reference numerals refer to like parts throughout the several views of the drawings.

### DETAILED DESCRIPTION OF THE PREFERRED EMBODIMENT

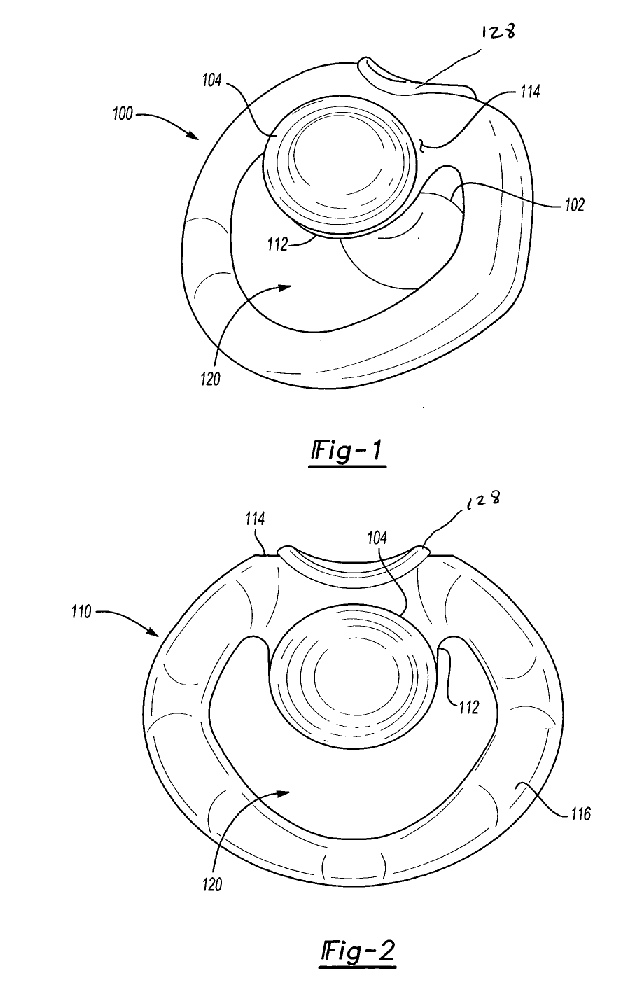

For purposes of description herein, the terms “upper”, “lower”, “left”, “rear”, “right”, “front”, “vertical”, “horizontal”, and derivatives thereof shall relate to the invention as oriented in FIG. 1, with the view of the pacifier when it is in the child's mouth being considered the front view. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

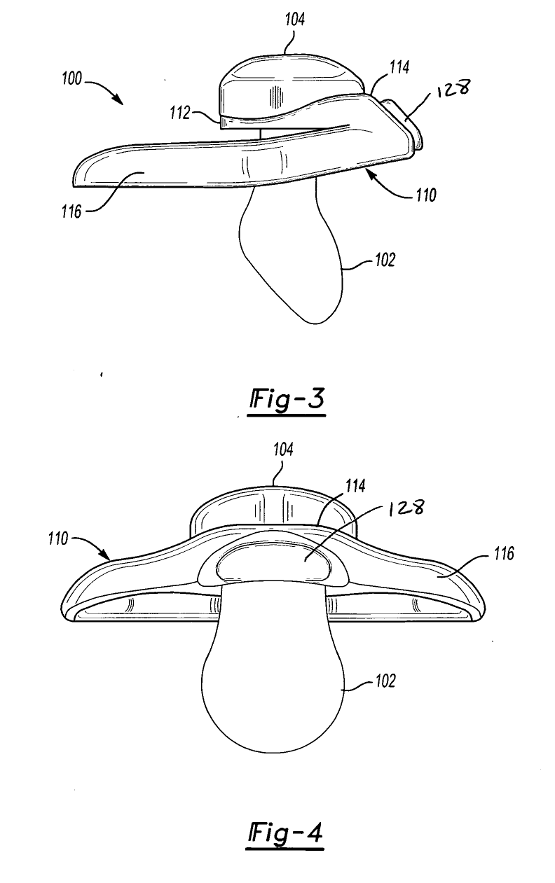

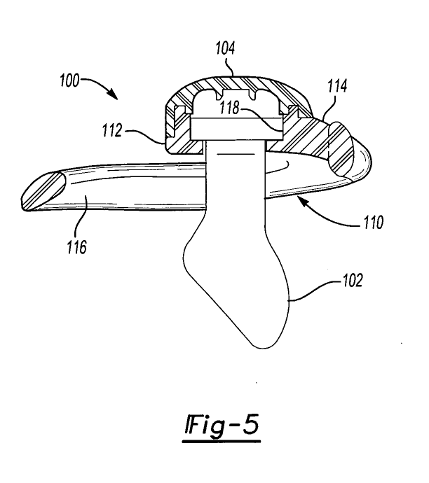

Turning now to the drawings, FIGS. 1-5 show a child's pacifier 100 that includes a shield 110. Pacifier shields such as shield 110 must have passages therethrough to permit sufficient airflow in the event a child gets the pacifier lodged in its airway. A shield according to one embodiment of the present invention has only one opening 120 therethrough defined by shield 110. Shield 110 is partially comprised of a baglet support 112 that defines an aperture 118 therethrough. Aperture 118 is sized to accept a baglet or nipple 102 the configuration of which can be any one of the many known baglet designs currently known in the art or subsequently provided. Baglet 102 is retained and fixed within aperture 118 by cap and post assembly 104. Cap and post assembly 104 is of a configuration known in the art and readily adaptable to the present invention and affixes to baglet support 112 in a snap-on manner, or can be permanently bonded to baglet support 112 with a non-toxic adhesive, or permanently welded, or so forth.

In addition to baglet support 112, shield 110 includes a support base 114 that extends from baglet support 112. Support base 114 can be integrally incorporated with baglet support 112 or be a prominent and distinct feature that extends from base 114. Support base 114 has further extending therefrom a rim 116. Rim 116 extends from each side of support base 114 in an arcuate manner forming a ring-like structure to define the outer periphery of shield 110. Those practiced in the art will readily recognize that the peripheral shape of rim 116 can be of any geometry that is convenient and practical to abut a child's mouth area. In combination, baglet support 112, support base 114 and rim 116 define therein a single opening 120 for passage of air. Such a single opening 120 maximizes the available airflow therethrough in the event that a child should get the pacifier lodged in its mouth or airway. The relatively large size of opening 120 compared to previous pacifier shields greatly reduces the danger of a child suffocating in the event of attempting to ingest the pacifier. Shield 110 is typically molded of a material that retains its molded shape but is yet sufficiently resilient to be comfortable during prolonged contact with the skin of the child's mouth area. In preferred embodiments of the invention, the pacifier shield described herein are made of nylon, although any suitable thermoplastic or other material can be used, whether PES (Polyethersulfone), ABS (Acrylonitrile Butadiene Styrene), polypropylene, or polycarbonate.

Preferably, the pacifier also has a nasal bumper 128 provided thereon as well. Nasal bumper 128 is a softer material placed onto the pacifier shield and which rests against the bottom of the child's nose when the pacifier is in the child's mouth. The nasal bumper is preferably overmolded onto the pacifier shield, and is further preferably a thermoplastic elastomer (TPE), whether Kraton or any other suitable soft material providing comfort against the baby's nose.

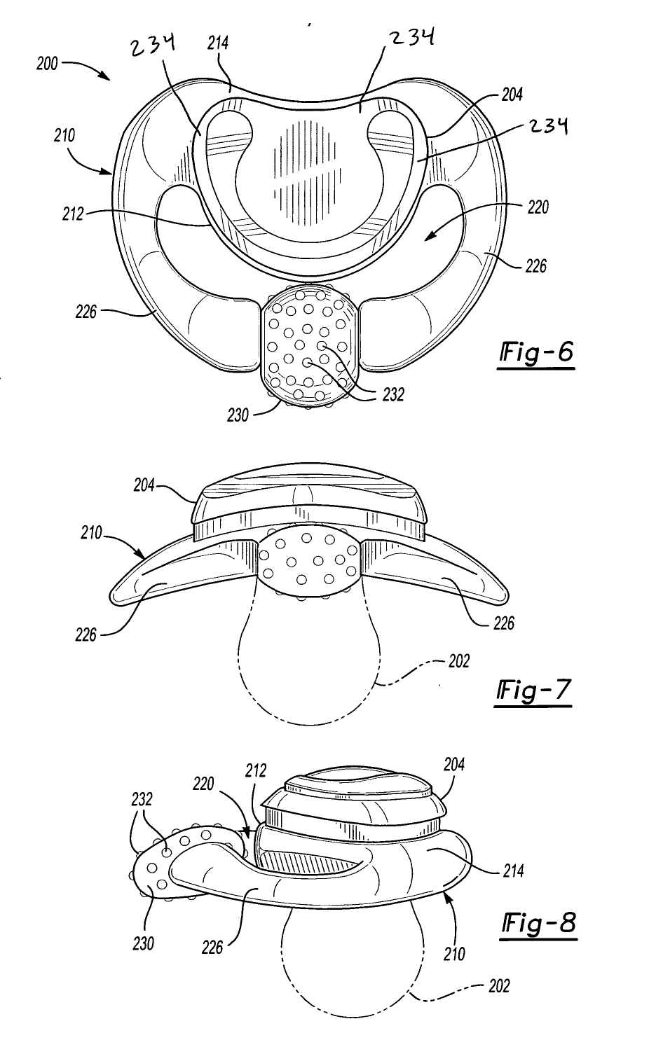

Referring now to FIGS. 6-8, a second alternative embodiment of a pacifier 200 according to the present invention is shown. Pacifier 200 includes a shield 210 having a baglet support 212 and a support base 214. An outer periphery of shield 210 is described by arms 226. One arm 226 extends from a first side of support base 214 and a second arm 226 extends from an opposite side of support base 214. Arms 226 arcuately extend to form the periphery of shield 210 in a geometric manner to comfortably abut a child's mouth area. In this embodiment, arms 226 have distal ends that support a teething knob 230 therebetween. Thus, baglet support 212, support base 214, arms 226, and teething knob 230 are peripherally joined to define a single opening 220 therebetween. Again, such a single opening maximizes the area available to provide sufficient airflow in the event pacifier 200 becomes lodged in the using child's airway.

Pacifier 200 also includes a cap and post assembly 204 affixed to shield 210 and retaining a baglet 202 therein. Teething knob 230 can be formed of any of the materials currently used for children's teething products (such as teething rings and so forth), or such materials used for that purpose in the future. In a preferred embodiment, the teething knob 230 is a thermoplastic elastomer (TPE), such as Kraton, overmolded onto a knob made of the shield material, as previously discussed with the nasal bumper 128. Teething knob 230 can function as a teething surface for the child to soothe the gum area of the child during the teething process. In a further alternative or additional embodiment, the thermoplastic elastomer can cover part or all of the teething knob; for example, in one preferred embodiment, the thermoplastic elastomer covers just the portion of the teething knob on the front of the pacifier. As a further teething aid and comfort to the child, teething knob 230 can also include a plurality of bumps 232 thereon.

Pacifier 200 preferably also includes a soft structure placed onto the post assembly 204 such as a soft overlay 234. As shown in FIG. 6, soft overlay 234 is a horseshoe shaped structure and is preferably a thermoplastic elastomer such as Kraton overmolded onto the pacifier as discussed above with respect to the nasal bumper.

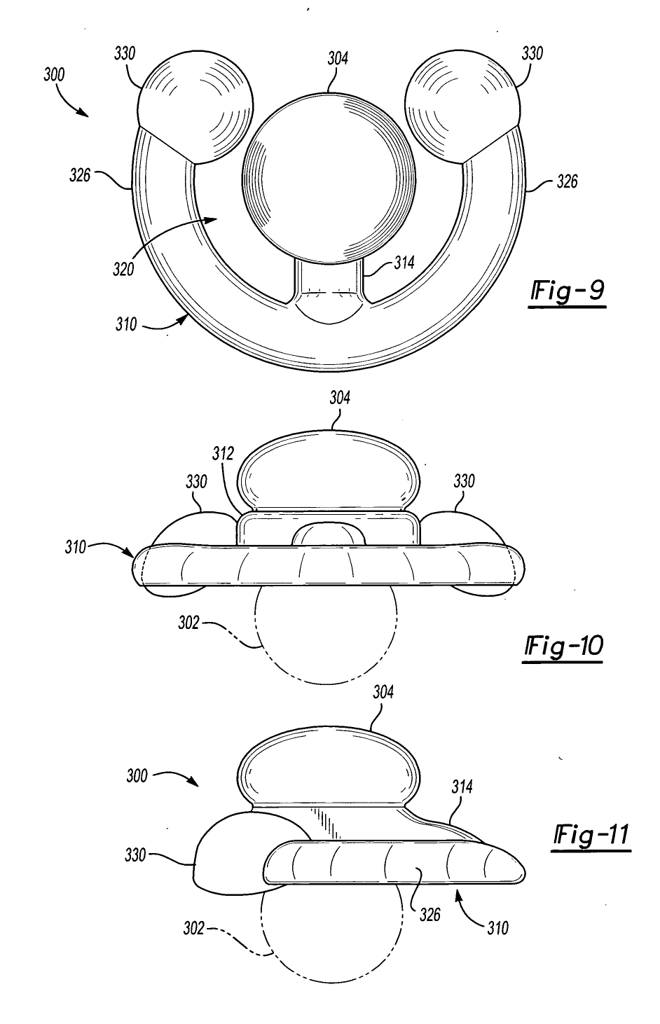

Yet another embodiment is illustrated as pacifier 300 in FIGS. 9-11. Pacifier 300 includes a shield 310 having a baglet support 312 to which a baglet is attached with a cap and post assembly 304 as described above in previous embodiments. A support base 314 radially extends from baglet support 312 and at a distal end thereof, arms 326 extend in opposite arcuate directions and are cantilevered at distal ends of arms 326. Arms 326 can have affixed at their respective distal ends teething knobs 330 (as discussed above regarding teething knob 230). As with pacifier 200, teething knobs 330 preferably has a thermoelastomer overmolded thereon and can also incorporate on a surface thereof bumps similar to bumps 232 for pacifier 200.

With respect to the shield embodiment 310 of these figures, the arms 326 remain in a cantilevered configuration and do not join to form a continuous periphery, in contrast to previous embodiments 110 and 210. In this manner, a gap or opening 320 is provided for passage of air therethrough. Unlike the openings described in the previous embodiments, the gap 320 is not a closed hole but rather is unbounded for at least a portion thereof as shown, for example, in FIG. 9. Stated in another fashion, the inner structures of the shield such as the cap and post assembly 304 and/or the support base 314 form a pacifier body from which extends arms 326, a gap being provided between the pacifier body and those arms.

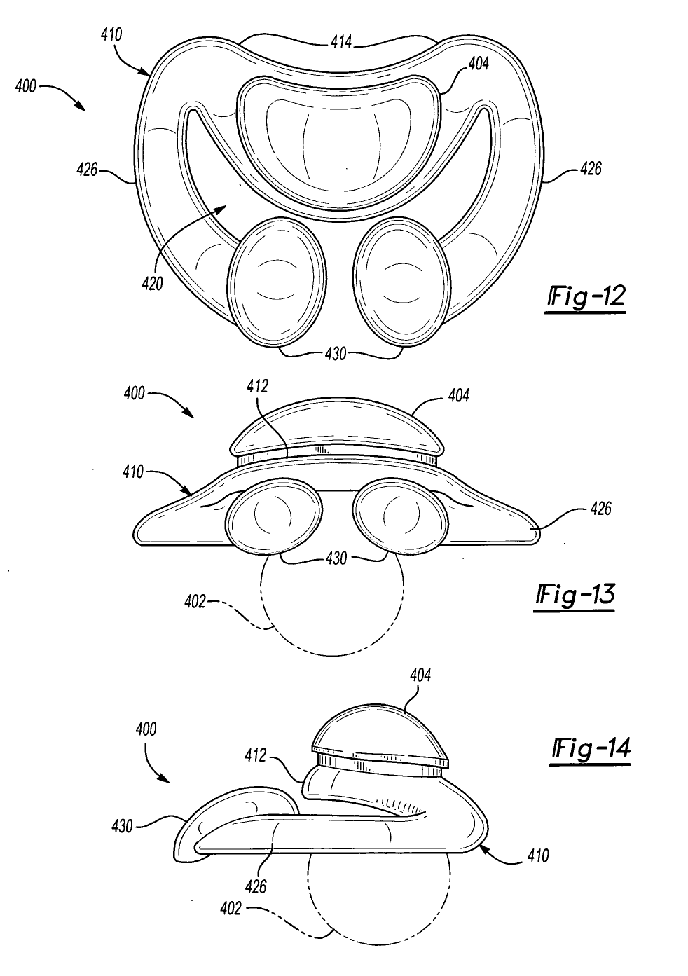

FIGS. 12-14 illustrate yet another embodiment that is similar to pacifier 300. In this embodiment support base 414 is more integral with baglet support 212 and incorporates a more streamlined appearance of cap and post assembly 404 and arms 426 extending therefrom. Arms 426 can also terminate in cantilevered fashion with teething knobs 430 attached at distal ends thereof.

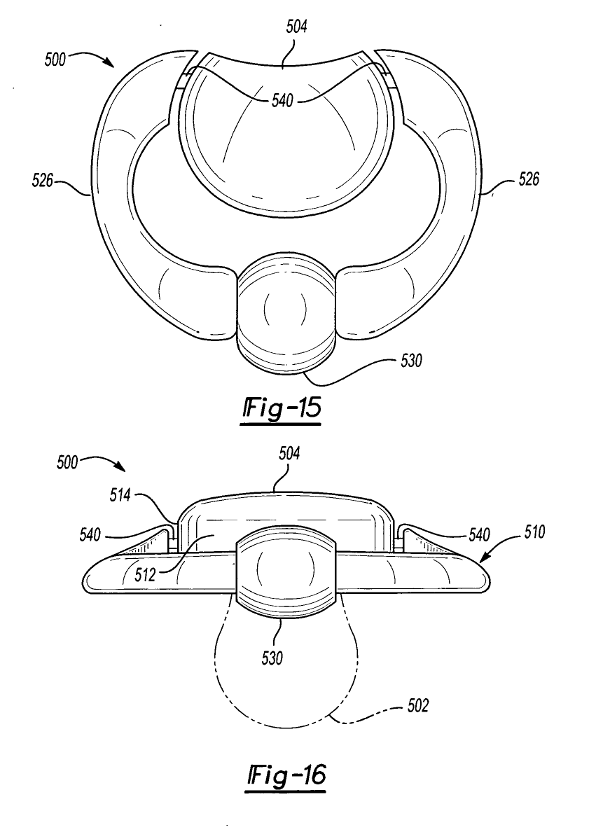

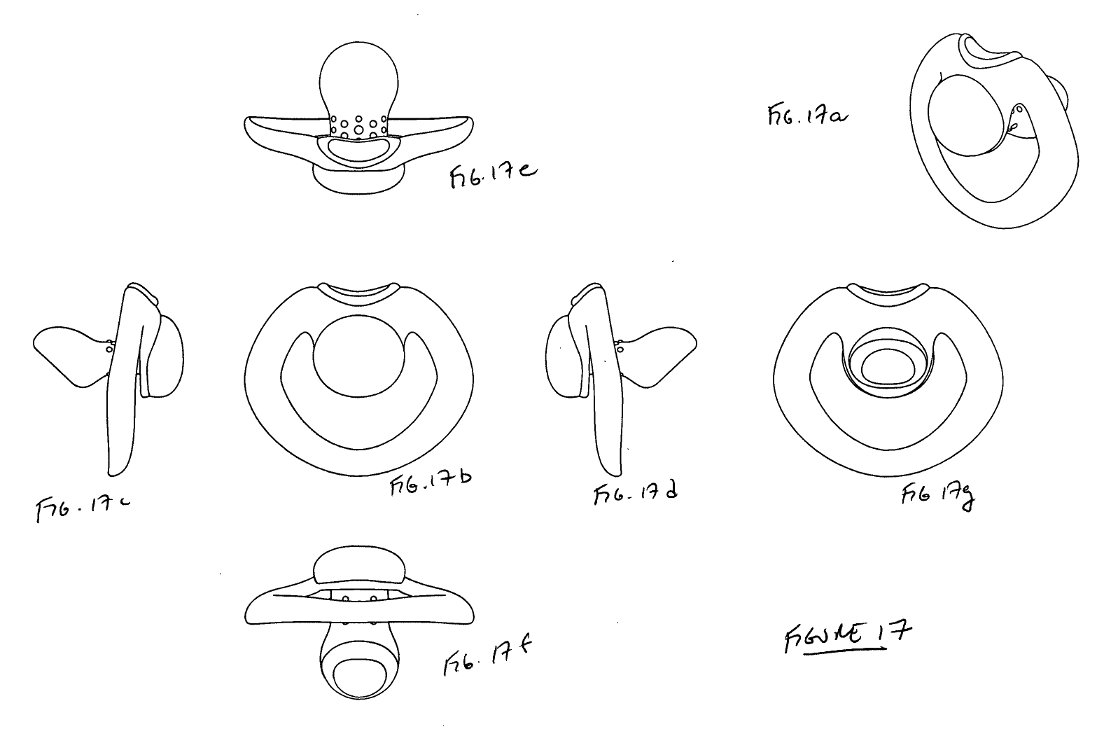

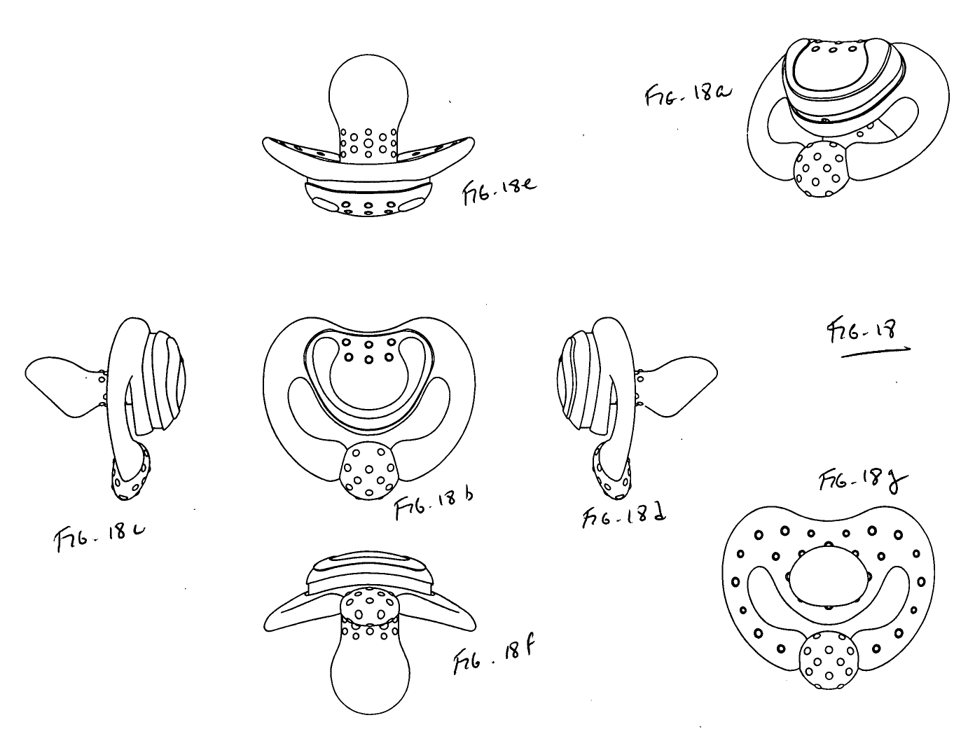

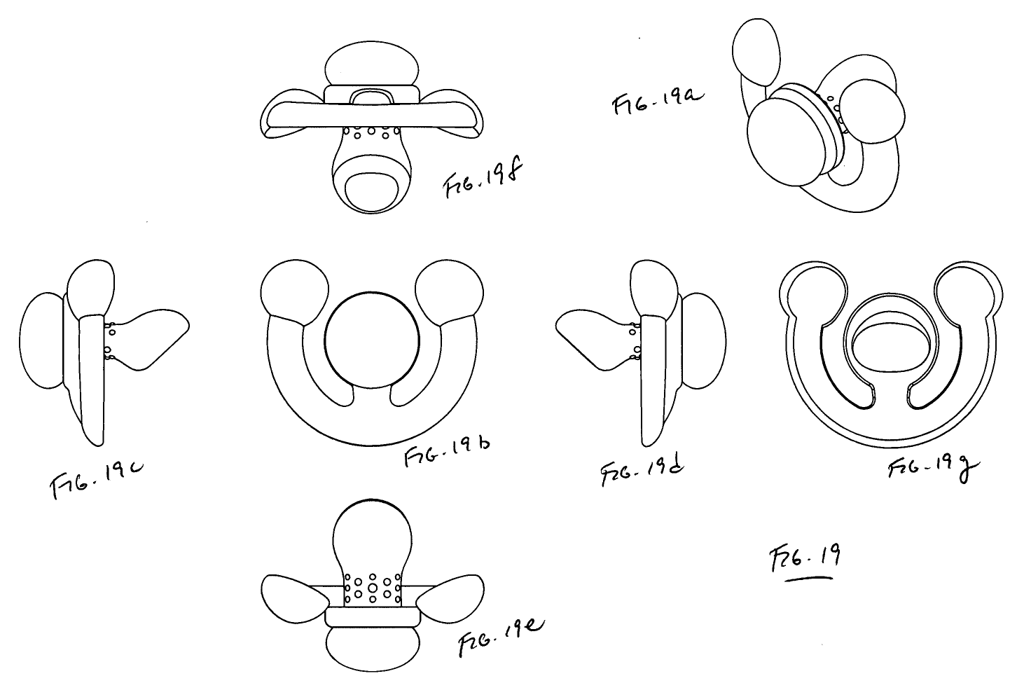

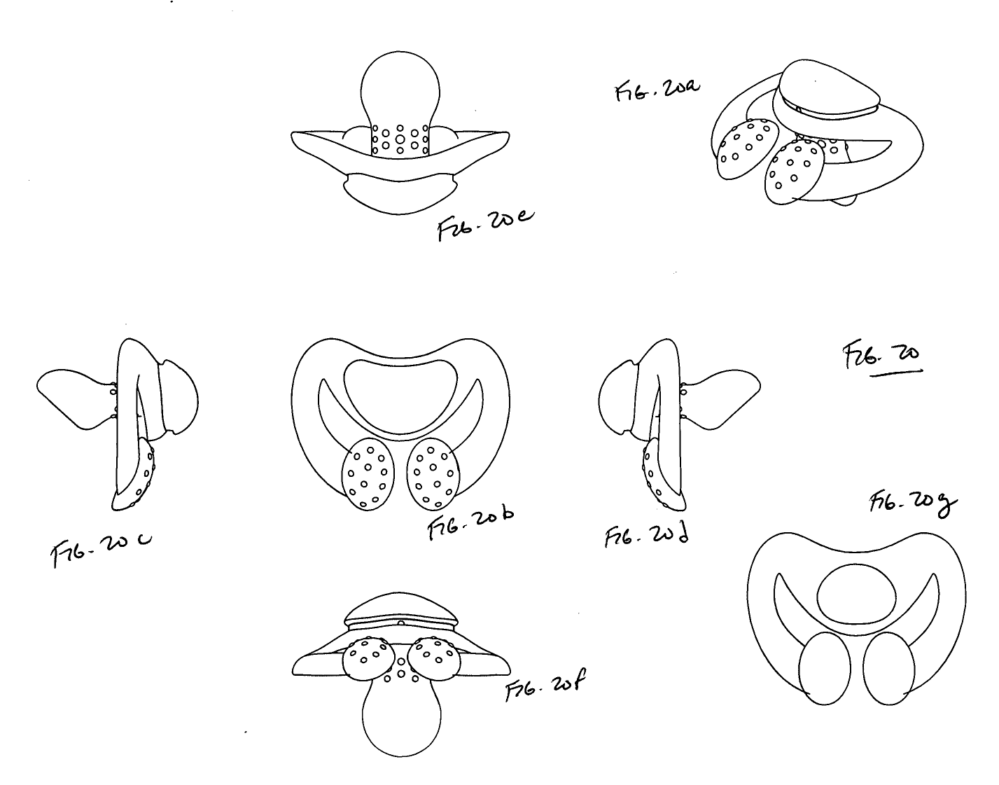

FIGS. 15-16 show still another embodiment of pacifier 500. Pacifier 500 includes a baglet support 512 in which is affixed baglet 502 for a child to suckle on with baglet 502 being affixed by cap and post assembly 504. Hinges 540 extend from opposite sides of support base 514. Arms 526 have one end attached to hinge 540 and extend from support base 514 in an arcuate manner such that the distal ends of arms 526 support therebetween a teething knob 530 in the same fashion as previously described for pacifier 200. Hinges 540 can be a small rod that extends from arm 526 and is inserted into support base 514. Hinge 540 can have an enlarged end to prevent removal from arm 526 or support base 514, yet permitting the pivoting or rotation of arms 526 about baglet support 512. In an alternate configuration, arms 526 could be connected to baglet support 512 at a single point, such as using a single hinge at an apex area of cap and post assembly 504.

Accordingly, as shown above, in any of the embodiments of the invention, less than two holes or openings (i.e. less than two air holes or air opening or vents) are provided in the shield of the pacifier. This design of the present pacifier provides significantly increased safety over the prior pacifiers of the art. In the event that a child swallows or attempts to swallow the pacifier, the design makes it easier for the child to pull air through the pacifier without choking, irrespective of the orientation of the pacifier in the child's mouth. In such event, the design also makes it easier for the mother or other caregiver to place here or his fingers through the pacifier to pull the pacifier out of the child's mouth.

Further to the invention, pacifiers and pacifier baglets of any desired type can be used consistent with the invention whether orthodontic pacifiers, or so forth. Likewise, the present invention can be used in conjunction with any of the features in the inventor's prior U.S. Pat. No. 6,241,110 entitled, “Baby Products and Methods of Manufacture”, and U.S. Patent Application Publication No. 20050288712 entitled, “Pacifier and Baby Bottle Nipples Systems”, which are fully incorporated herein by reference.

The above description is considered that of various embodiments and preferred embodiments of the invention, and modifications of the invention will be apparent to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

I claim:

1. An article of manufacture,
said article comprising a pacifier product,
said pacifier product comprising a pacifier shield,
said pacifier shield having less than two holes for ventilation of air through said pacifier shield.

2. An article as claimed in claim 1, wherein said pacifier comprises one air hole through said pacifier shield.

3. An article as claimed in claim 1, wherein said pacifier comprises no air holes through said pacifier shield.

4. An article as claimed in claim 3, wherein said pacifier shield comprises a body and arms, said pacifier shield comprising a gap between said body and said arms, and wherein air passes through said gap.

5. A pacifier, comprising:
a shield including:
a baglet support defining an aperture therethrough;
a support base extending from said baglet support; and
a rim extending from said support base, wherein:
said baglet support, said support base, and said rim in combination define a single opening in said shield; and
a baglet configured for a child to suckle on, said baglet affixed to said baglet support in said aperture.

6. The pacifier according to claim 5 wherein said rim extends from a first side of said support base in an arcuate fashion to an opposite side of said support base.

7. The pacifier according to claim 6 wherein said rim is hingedly attached to said support base such that said rim is free to arcuately rotate with respect to said baglet support.

8. The pacifier according to claim 5 wherein said rim comprises at least two arms oppositely extending from said support base.

9. The pacifier according to claim 8 wherein ends of said arms opposite from said support base support a teething knob therebetween.

10. The pacifier according to claim 9 wherein said arms comprise a first material and said teething knob comprises a second material, said second material being harder than said first material.

11. The pacifier according to claim 9 wherein said arms are hingedly attached to said support base such that said rim is free to arcuately rotate with respect to said baglet support.

12. The pacifier according to claim 9 wherein said teething knob includes a plurality of bumps on an outer surface thereof.

13. The pacifier according to claim 9 wherein each of said arms at an end opposite from said support base has a teething knob affixed thereto, said teething knobs spaced being spaced apart one from the other.

14. The pacifier according to claim 13 wherein said arms comprise a first material and said teething knobs comprise a second material, said second material being harder than said first material.

15. The pacifier according to claim 13 wherein each of said teething knobs includes a plurality of bumps on an outer surface thereof.

16. A pacifier shield for use in a child's pacifier of the type having a baglet adapted for a child to suckle on, said pacifier shield comprising:
a baglet support defining an aperture therethrough for receiving a baglet therein;
a support base extending from said baglet support; and
a rim extending from said support base, wherein:
said baglet support, said support base, and said rim in combination define a single opening in said shield.

17. The pacifier according to claim 16 wherein said rim extends from a first side of said support base in an arcuate fashion to an opposite side of said support base.

18. The pacifier according to claim 17 wherein said rim is hingedly attached to said support base such that said rim is free to arcuately rotate with respect to said baglet support.

19. The pacifier according to claim 16 wherein said rim comprises at least two arms oppositely extending from said support base.

20. The pacifier according to claim 19 wherein ends of said arms opposite from said support base support a teething knob therebetween.

21. The pacifier according to claim 20 wherein said arms comprise a first material and said teething knob comprises a second material, said second material being harder than said first material.

22. The pacifier according to claim 20 wherein said arms are hingedly attached to said support base such that said rim is free to arcuately rotate with respect to said baglet support.

23. The pacifier according to claim 20 wherein said teething knob includes a plurality of bumps on an outer surface thereof.

24. The pacifier according to claim 19 wherein each of said arms at an end opposite from said support base has a teething knob affixed thereto, said teething knobs spaced being spaced apart one from the other.

25. The pacifier according to claim 24 wherein said arms comprise a first material and said teething knobs comprise a second material, said second material being harder than said first material.

26. The pacifier according to claim 24 wherein each of said teething knobs includes a plurality of bumps on an outer surface thereof.
